(19) United States
(12) Patent Application Publication
(10) Pub. No.: US 2010/0238133 A1
(43) Pub. Date: Sep. 23, 2010

(54) CAPACITIVE TOUCH PANEL

(75) Inventors: Hsien-Hsin Wu, Taichung City (TW); Ping-Wen Huang, Taichung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: WINTEK CORPORATION, Taichung (TW)

(21) Appl. No.: 12/722,533

(22) Filed: Mar. 12, 2010

(30) Foreign Application Priority Data
Mar. 17, 2009 (TW) 98108626
Sep. 11, 2009 (TW) 98130800

(51) Int. Cl. G06F 3/045

(52) U.S. Cl. 345/174

(57) ABSTRACT

A capacitive touch panel including a first substrate and the elements disposed on the first substrate such as a plurality of first sensing series, a plurality of second sensing series, and a plurality of compensating patterns. Each of the first sensing series is formed by first electrodes serially connected through first connecting lines in a first direction, and each of the second series is formed by second electrodes serially connected through second connecting lines in a second direction intersecting the first direction. The first electrodes and the second electrodes are electrically insulated from one another. Each of the first electrodes is separated from one of the second electrodes by a gap in a horizontal direction parallel to the first substrate. The compensating patterns are located inside the gaps.

### CROSS-REFERENCE TO RELATED APPLICATION

This application claims the priority benefit of Taiwan applications serial no. 98108626, filed on Mar. 17, 2009, and serial no. 98130800, filed on Sep. 11, 2009. The entirety of each of the above-mentioned patent applications is hereby incorporated by reference herein and made a part of specification.

### BACKGROUND OF THE INVENTION

1. Field of the Invention

The invention relates to a touch panel. More particularly, the invention relates to a capacitive touch panel.

2. Description of Related Art

FIG. 1 is a schematic top view illustrating a part of a conventional capacitive touch panel. Referring to FIG. 1, the capacitive touch panel 100 includes a substrate 110, a first electrode layer 120, a second electrode layer 130, and a dielectric layer 140, wherein the first electrode layer 120 and the second electrode layer 130 are disposed on the substrate 110. The first electrode layer 120 is formed by a plurality of first electrodes 122, and the second electrode layer 130 is formed by a plurality of second electrodes 132.

As shown in FIG. 1, when a display panel disposed underlying the capacitive touch panel 100 displays, the displaying light irradiates on the capacitive touch panel 100 from the bottom of the substrate 110 and passing through the capacitive touch panel 100. That is to say, the displaying light passes through the drawing sheet from the backside of the drawing sheet. Specifically, the displaying light passes through the first electrode 122 and the dielectric layer 140 at position A, passes through the second electrode 132 and the dielectric layer 140 at position B, and passes through merely the dielectric layer 140 at position C.

Nevertheless, the physical phenomenon including refraction, reflection or transmission occurs if the light passes through the interface of different materials so that the brightness represented by the light at different locations are varied. In addition, the first electrodes 122 and the second electrodes 132 are separated by a gap G. Accordingly, the image with uneven brightness is viewed by human eyes. Particularly, the image brightness corresponding to the location of the gap G and that corresponding to the location of the electrodes 122 and 132 are significantly varied.

### SUMMARY OF THE INVENTION

The invention is directed to a capacitive touch panel, wherein the characteristics of the film layers disposed in the capacitive touch panel and the dispositions of the aforesaid film layers are conducive to improve the optical properties of the capacitive touch panel.

The invention provides a capacitive touch panel including a first substrate and the elements such as a plurality of first sensing series, a plurality of second sensing series, and a plurality of compensating patterns disposed on the first substrate. Each of the first sensing series is formed by first electrodes serially connected through first connecting lines in a first direction, and each of the second series is formed by second electrodes serially connected through second connecting lines in a second direction intersecting the first direction. The first electrodes and the second electrodes are electrically insulated from one another. Each of the first electrodes is separated from adjacent one of the second electrodes by a gap in a horizontal direction parallel to the first substrate. The compensating patterns are located inside the gaps. A difference between a refraction index of the compensating patterns and a refraction index of the first electrodes is at least small than 0.5, and the refraction index of the first electrodes is substantially equal to a refraction index of the second electrodes.

In view of the above, the capacitive touch panel of the invention has a plurality of compensating patterns respectively located between the first electrodes and the adjacent second electrodes so that the evenness of light transmittance of the capacitive touch panel is improved.

In order to make the aforementioned and other objects, features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic top view illustrating a part of a conventional capacitive touch panel.

FIG. 2 is a schematic top view illustrating a part of a capacitive touch panel according to a first embodiment of the invention.

FIG. 3 is a schematic cross-sectional view illustrating a part of a capacitive touch panel according to the first embodiment of the invention.

FIG. 4 is a schematic cross-sectional view illustrating a part of a capacitive touch panel according to a second embodiment of the invention.

FIG. 5 and FIG. 6 are schematic top views illustrating two capacitive touch panels according to a third embodiment of the invention.

FIG. 7 is a schematic cross-sectional view illustrating a part of a capacitive touch panel according to a third embodiment of the invention.

FIG. 8 to FIG. 10 are schematic cross-sectional views illustrating three capacitive touch panels according to a fourth embodiment of the invention.

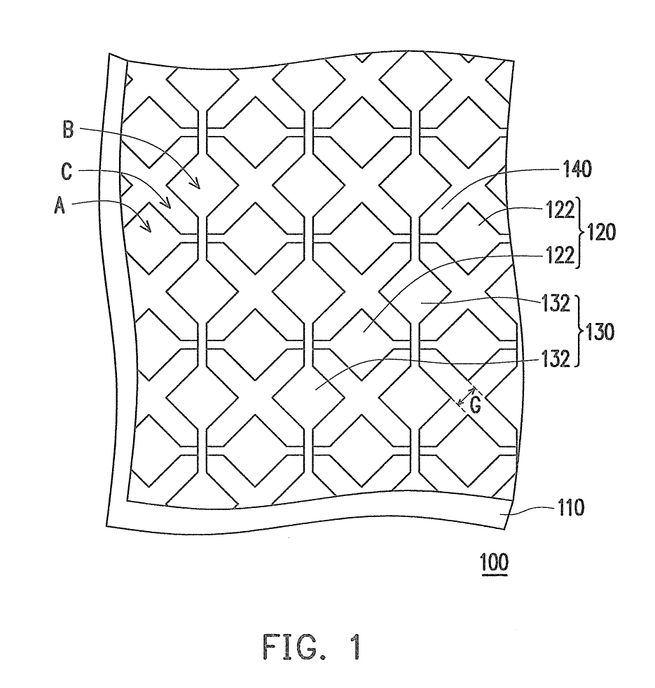

### DESCRIPTION OF EMBODIMENTS

To depict the spirit of the invention, the following embodiments are described as examples, but the invention is not limited to the descriptions in the embodiments.

### The First Embodiment

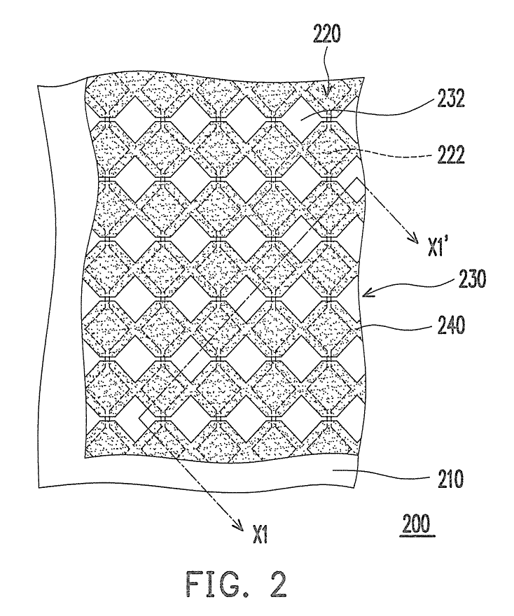

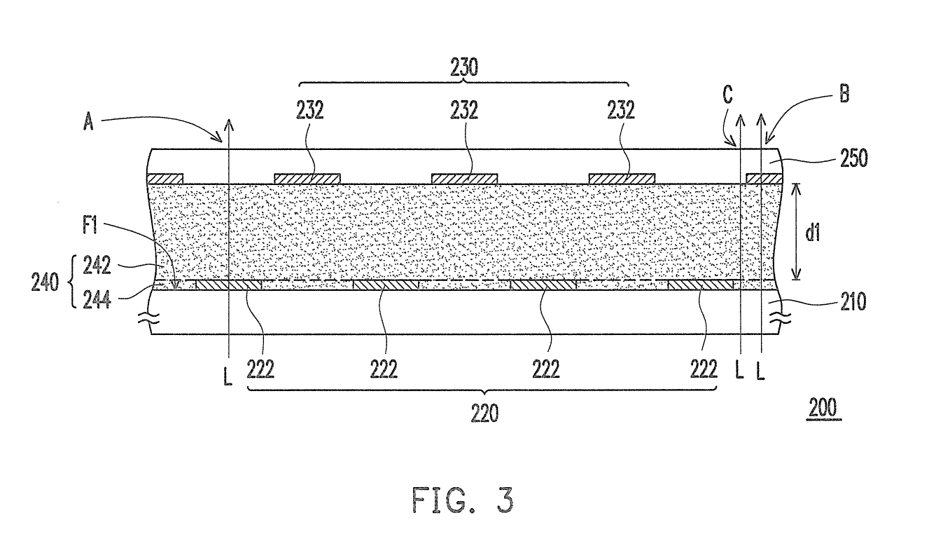

Referring to FIGS. 2 and 3 simultaneously, the capacitive touch panel 200 includes a substrate 210, a plurality of first sensing series 220, an insulator structure 240, a plurality of second sensing series 230 and a protection layer 250 sequentially arranged according to the present embodiment. Each of the first sensing series 220 includes a plurality of first electrodes 222 serially connected in a first direction through corresponding first connecting lines. Each of the second sensing series 230 includes a plurality of second electrodes 232 serially connected in a second direction through corresponding second connecting lines, wherein the first direction intersects the second direction. A material of the first electrodes 222 and the second electrodes 232 is a transparent conductive material such as indium tin oxide (ITO), indium zinc oxide (IZO), and the like. The insulator structure 240 is divided into an insulator layer 242 and a plurality of first compensating portions 244 connected to the insulator layer 242. Particularly, the insulator layer 242 and the first compensating portions 244 can be made by the same material.

As shown in FIGS. 2 and 3, the substrate 210 is not completely covered by the first electrodes 222 so that the portion of the substrate 210 exposed by the first electrodes 222 demarcate a plurality of filling portions F1, and the first compensating portions 244 are disposed inside the filling portions F1.

In the present embodiment, the light L which transmits from the bottom of the substrate 210 to the passivation layer 250 sequentially passes through the first electrode 222 and the insulator layer 242 at position A, sequentially passes through the first compensating portion 244, the insulator layer 242, and the second electrode 232 at position B, and sequentially passes through the first compensating portion 244 and the insulator layer 242 at position C. The first compensation portions 244 and the insulator layer 242 are made by the same material, and the refraction index of the first compensating portions 244 is similar to the refraction index of the first electrodes 222 and that of the second electrodes 232 in the present embodiment. Accordingly, the optical effects such as refraction, reflection, and the like which the light L is subjected to are substantially equivalent in the first compensating portions 244, the insulator layer 242, and the second electrodes 232. Therefore, the capacitive touch panel 200 has even light transmittance based on the disposition of the first compensating portions 244.

Specifically, the difference between the refraction index of the electrodes such as the first electrodes 222 and the second electrodes 232 and the refraction index of the first compensating portions 244 is, for example, at least less than 0.5. If the first electrodes 222 and the second electrodes 232 are made by indium tin oxide, the refraction index of the first electrodes 222 and that of the second electrodes 232 are substantially 2.06. Therefore, the material having a refraction index close to 2.06 is selected to fabricate the insulator structure 240 during fabricating the capacitive touch panel 200. For example, the material may be dielectric material such as organic material or oxide with the refraction index from 1.55 to 2.5. Preferably, the material can be the dielectric material such as HfO₂, Nb₂O₅, Ta₂O₅, or the like having the refraction index from 1.7 to 2.4. Practically, the dielectric materials having the refraction index from 1.55 to 2.5 are too numerous to enumerate and are not completely listed.

In another embodiments, the difference between the refraction index of the insulator structure 240 and the refraction index of the electrodes such as the first electrodes 240 and the second electrodes 232 is, for example, less than 0.5. In further another embodiment, the dielectric material and the transparent conductive material having similar refraction index can be selected to fabricate the insulator layer 240 and the electrodes including the first electrodes 222 and the second electrodes 232, respectively.

It is noted that the whole intensity consumption of the light L sequentially passing through the insulator structure 240 and the second electrodes 232 is substantially equal to the intensity consumption of the light L merely passing through the insulator layer 242 if a thickness d1 of the insulator layer 242 is larger than 0.5 um. Owing to that the brightness of the light L highly depends upon the intensity of the light L, the brightness of the light L passing through the insulator structure 240 and the second electrodes 222 is equivalent to the brightness of the light L merely passing through the insulator layer 242.

Accordingly, the capacitive touch panel 200 provides desirable light transmittance. Based on the above, the capacitive touch panel 200 applied to a touch display is conducive to improve the evenness of the brightness of the touch display to make the touch display have good display quality.

### The Second Embodiment

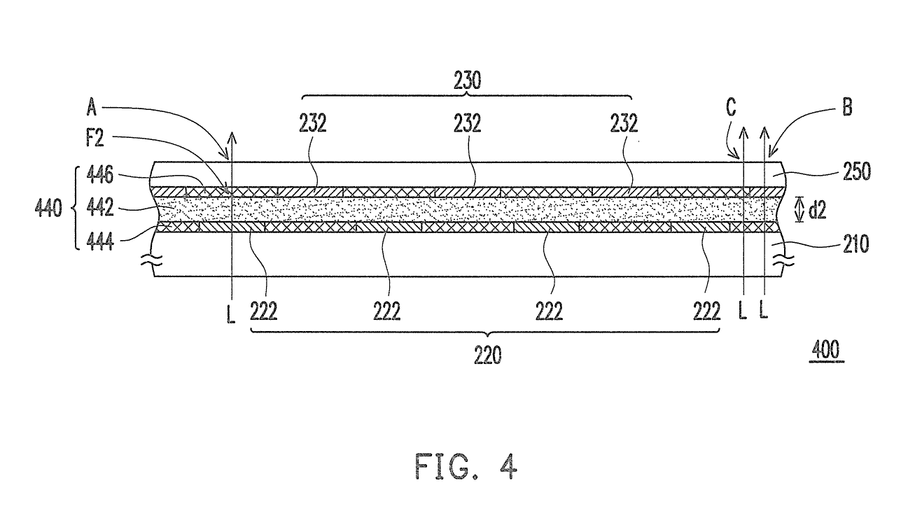

FIG. 4 is a schematic cross-sectional view illustrating a part of a capacitive touch panel according to a second embodiment of the invention. Referring to FIG. 4, the capacitive touch panel 400 illustrated in this embodiment is similar to the capacitive touch panel 200 illustrated in the first embodiment, wherein the same or similar elements are indicated by the same or similar reference numbers. The descriptions thereof are therefore not repeated here. The main difference between the first embodiment and the second embodiment is that the insulator structure 440 of the capacitive touch panel 400 according to the second embodiment includes the insulator layer 442, the first compensating portions 444, and the second compensating portions 446. Herein, the material of the insulator layer 442 differs from the material of the first compensating portions 444 and the second compensating portions 446. In addition, the thickness of the insulator layer 442 of the insulator structure 440 is not limited in the present embodiment.

As shown in FIG. 4, the arrangement of the first compensating portions 444 can be referred to the related description of the first embodiment and is omitted. The second compensating portions 446 are located between two adjacent second electrodes 232. Specifically, a plurality of filling portions F2 are demarcated between two adjacent second electrodes 232, and the second compensating portions 446 are disposed inside the filling portions F2.

In the present embodiment, the refraction index of the first electrodes 222 varies the refraction index of the first compensating portions 444 by at least smaller than 0.5, and the refraction index of the second electrodes 232 varies the refraction index of the second compensating portions 446 by at least smaller than 0.5. Therefore, the optical effect which the light L is subjected to after passing through the first electrodes 222 is deemed as the optical effect which the light L is subjected to after passing through the first compensating portions 444. Similarly, the optical effect which the light L is subjected to after passing through the second electrodes 232 is deemed as the optical effect which the light L is subjected to after passing through the second compensating portions 446. Namely, the optical effects such as refraction, reflection, and the like which the light L is subjected to after passing through the capacitive touch panel 400 are substantially the same at positions A, B, and C. Accordingly, the capacitive touch panel 400 provides desirable optical property.

If the first electrodes 222 and the second electrode 232 are, for example, made by indium tin oxide having the refraction index of 2.06, the first compensating portions 444 and the second compensating portions 446 are made by the materials having the refraction index close to 2.06. For example, the material for fabricating the first compensating portions 444 and the second compensating portions 446 is dielectric material such as organic material or oxide having the refraction index from 1.55 to 2.5. Preferably, the material for fabricating the first compensating portions 444 and the second compensating portions 446 is dielectric material such as HfO₂, Nb₂O₅, or Ta₂O₅ having the refraction index from 1.7 to 2.4. Practically, the dielectric materials having the refraction index from 1.55 to 2.5 are too numerous to enumerate and are not completely listed.

The optical effects which the light L is subjected to in the capacitive touch panel 400 are adjusted and compensated by using the dielectric material having specific refraction index. Therefore, the light L transmitting at different paths is subjected to similar optical effects no matter what the thickness d2 of the insulator layer 442 according to the present embodiment is. As such, the thickness d2 of the insulator layer 442 according to the present embodiment is adjustable and not limited. The whole thickness of the capacitive touch panel 400 is reduced along with the reduction of the thickness d2 of the insulator layer 442 so that the capacitive touch panel 400 has the characteristic of thin volume.

Based on the above, the capacitive touch panel 400 applied to a touch display is conducive to improve the evenness of the brightness of the touch display to make the touch display have good display quality.

### The Third Embodiment

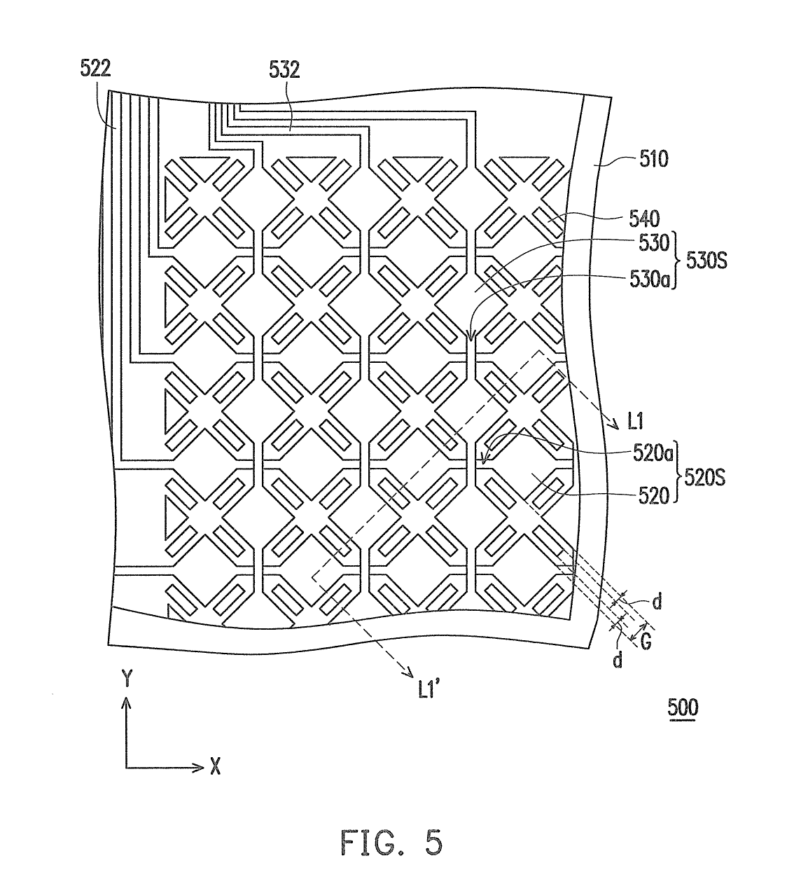

Referring to FIGS. 5, 6, and 7 simultaneously, the capacitive touch panel 500 according to the present embodiment includes a first substrate 510, a plurality of first sensing series 520S, a plurality of second sensing series 530S, and a plurality of electrode compensating patterns 540. Each of the first sensing series 520S is formed by first electrodes 520 serially connected through first connecting lines 520a in a first direction X, and each of the second series 530S is formed by second electrodes 530 serially connected through second connecting lines 530a in a second direction Y intersecting the first direction X. The first electrodes 520, the second electrodes 530, and the electrode compensating patterns 540 are coplanar disposed on the first substrate 510, for example.

In addition, the first electrodes 520, the second electrodes 530, and the electrode compensating patterns 540 are made by the same material such as indium tin oxide, indium zinc oxide, etc. The first substrate 510 can be a transparent glass, a color filter, a plastic film, or a cover lens.

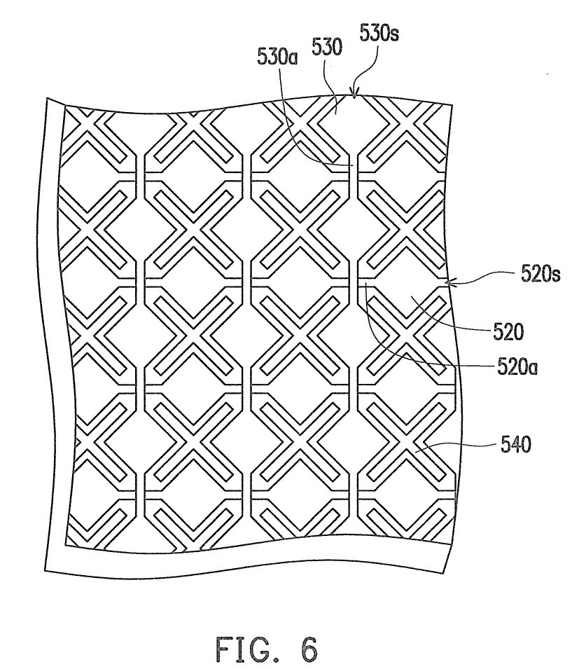

It is noted that the first connecting lines 520a and the second connecting lines 530a are electrically insulated from one another so that the capacitive touch panel 500 can work normally. On the other hand, the layout of the first connecting lines 520a and the second connecting lines 530a are decided according to the real products. The disposition of the first connecting lines 520a and the second connecting lines 530a illustrated in FIGS. 5 and 6 are schematically shown, but not the real circumstance. In an embodiment, the material of the first connecting lines 520a and the second connecting lines 530a can be transparent conductive material such as indium tin oxide, indium zinc oxide, or the like, or metal.

Specifically, for connecting the first sensing series 520S and the second sensing series 530S with an outer circuit (e.g. the signal pads, the outer wires, the connecter, etc.), a plurality of first conductive lines 522 and a plurality of second conductive lines 532 are disposed on the first substrate 510. The first conductive lines 522 are electrically connected to the corresponding first sensing series 520S to transmit the voltage signal of the first sensing series 520S. The second conductive lines 532 are electrically connected to the corresponding second sensing series 530S to transmit the voltage signal of the second sensing series 530S.

In the present embodiment, the first sensing series 520S and the second sensing series 530S are electrically insulated from each other, wherein each of the first electrodes 520 is separated from one adjacent second electrode 530 by a gap G in a horizontal direction parallel to the first substrate 510. When the first electrodes 520 and the second electrodes 530 are applied by suitable voltages, a capacitance effect is generated between the first electrodes 520 and the second electrodes 530. Specifically, the gap G is about 100 um, but not limited in the invention. The gap G can be modified based on the requirement of the real products.

The electrode compensating patterns 540 are located inside the gap G and electrically insulated from the first electrodes 520 and the second electrodes 530, wherein each of the electrode compensating patterns 540 is separated from the adjacent first electrode 520 or the adjacent second electrode 530 by a distance d. The distance d can be from 10 um to 30 um, and the invention is not limited thereto. Specifically, the distance d can be larger or smaller than the aforesaid value based on the requirement of the real products or the accuracy of the fabrication process.

In addition, the electrode compensating patterns 540 are stripe-shaped as shown in FIG. 5 and every electrode compensating pattern 540 is adjacent to one of the first electrodes 520 and one of the second electrodes 530. Moreover, at least a part of the electrode compensating patterns 540 can be connected to one another to form a plurality of crisscross electrode patterns as shown in FIG. 6 based on other embodiments.

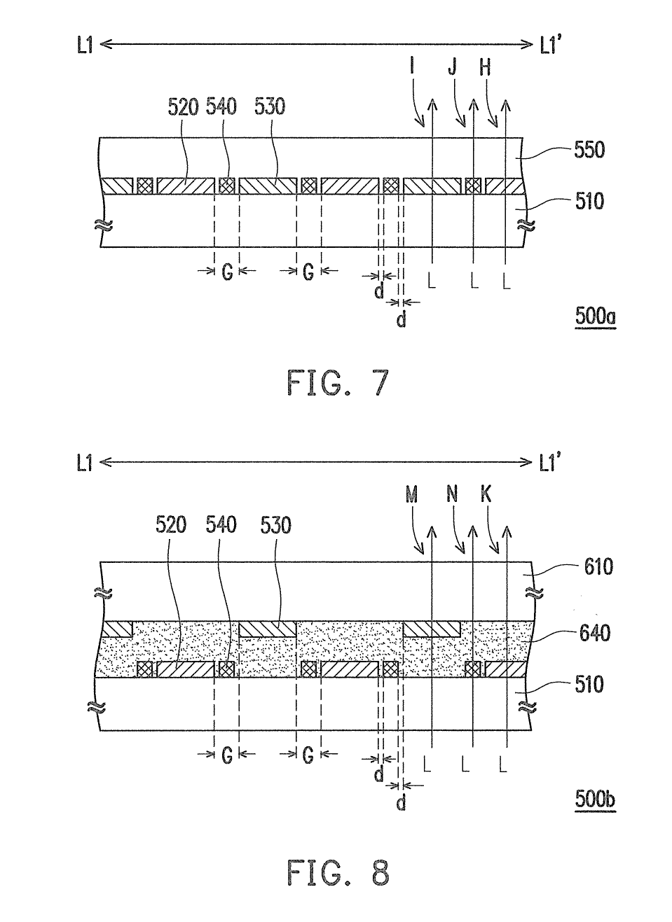

Based on the drawing of FIG. 7, the light L which irradiates the capacitive touch panel 500a from the bottom of the first substrate 510 sequentially passes through the first substrate 510 and the first electrode 520 at position H, sequentially passes through the first substrate 501 and the second electrode 530 at position I, and sequentially passes through the first substrate 510 and the electrode compensating pattern 540 at position J. The first electrodes 520, the second electrodes 530, and the electrode compensating patterns 540 are made by the same material and have the same refraction index so that the optical effects such as refraction and reflection which the light L is subjected to at positions H, I, and J are substantially equivalent. Accordingly, the electrode compensating patterns 540 can be deemed as the compensating patterns providing optical adjustment and compensation effect.

The electrode compensating patterns 540 are separated from the first electrodes 520 or the second electrodes 530 by the distance d in the present embodiment, but the distance d is too small to be seen by human eyes. Therefore, the light transmittance of the capacitive touch panel 500a is uniform at different positions.

Simultaneously, the electrode compensating patterns 540 are floating conductive patterns so that the capacitance effect generated between the first electrodes 520 and the second electrodes 530 are not affected thereby. In other words, the electrode compensating patterns 540 is conducive to improve the optical property of the capacitive touch panel 500a without affecting the touch function of the capacitive touch panel 500a. Moreover, the electrode compensating patterns 540, the first electrodes 520, and the second electrodes 530 are fabricated in the same process so that the disposition of the electrode compensating patterns 540 does not increase the burden of the fabrication and the cost.

### The Fourth Embodiment

FIGS. 8 to 10 illustrate cross-sectional views of different capacitive touch panels according to the line L1-L1′ in FIG. 5. The spirit of the present embodiment is similar to that described in the third embodiment, wherein the main difference between the present embodiment and the third embodiment is that the first electrodes 520 and the second electrodes 530 of the capacitive touch panels 500b, 500c, and 500d are not coplanar disposed.

Referring to FIG. 8, the capacitive touch panel 500b further includes a second substrate 610 and an insulator layer 640 disposed between the first substrate 510 and the second substrate 610. The first electrodes 520 and the electrode compensating patterns 540 are disposed between the insulator layer 640 and the first substrate 510. The second electrodes 530 are disposed between the insulator layer 640 and the second substrate 610. In other words, the first electrode 520 and the second electrodes 530 are disposed at two opposite sides of the insulator layer 640, and the electrode compensating patterns 540 and the first electrodes 520 are coplanar disposed. The first substrate 510 or the second substrate 610 can be a transparent glass, a color filter, a plastic film, or a cover lens.

As shown in FIG. 8, the light L transmitting from the bottom of the first substrate 510 to the second substrate 610 passes through the first electrode 520 and the insulator layer 640 at position K, passes through the insulator layer 640 and the second electrode 530 at position M, and passes through the electrode compensating pattern 540 and the insulator layer 640 at position N. In the present embodiment, the first electrodes 520, the second electrodes 530, and the electrode compensating patterns 540 are made by the same material and having the same refraction index. Accordingly, the optical effects such as refraction, reflection, and the like which the light L is subjected to is substantially equivalent at different positions so that the capacitive touch panel 500b has even light transmittance.

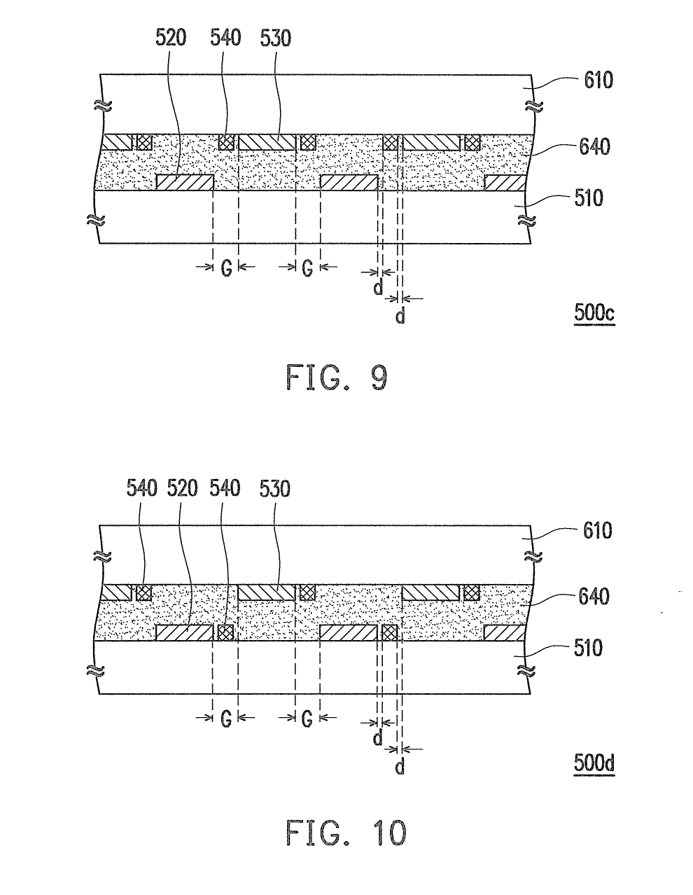

However, the embodiments are not limited to the aforesaid description. For example, the electrode compensating patterns 540 are disposed between the second substrate 610 and the insulator layer 640 so that the electrode compensating patterns 540 and the second electrodes 530 are coplanar in the capacitive touch panel 500c illustrated in FIG. 9. In addition, some of the electrode compensating patterns 540 are disposed between the second substrate 610 and the insulator layer 640 and the rest electrode compensating patterns 540 are disposed between the first substrate 510 and the insulator layer 640 in the capacitive touch panel 500d illustrated in FIG. 10. Namely, a part of the electrode compensating patterns 540 are coplanar with the first electrodes 520, and the rest electrode compensating patterns 540 are coplanar with the second electrodes 530.

Although the present invention has been disclosed by the above embodiments, they are not intended to limit the present invention. Any person having ordinary knowledge in the art may make some modifications and alterations without departing from the spirit and scope of the present invention. Therefore, the scope for which protection is sought by the present invention falls in the appended claims.

What is claimed is:

1. A capacitive touch panel, comprising:
a first substrate;
a plurality of first sensing series disposed on a surface of the first substrate, and each of the first sensing series having a plurality of first electrodes and a plurality of first connecting lines, wherein the first connecting lines serially connect the first electrodes in a first direction;
a plurality of second sensing series, each of the second sensing series having a plurality of second electrodes and a plurality of second connecting lines, the second connecting lines serially connecting the second electrodes in a second direction intersecting the first direction, and the first sensing series being electrically insulated from the second sensing series, wherein each of the first electrodes is separated from adjacent one of the second electrodes by a gap in a horizontal direction parallel to the first substrate; and
a plurality of compensating patterns disposed inside the gaps, a difference between a refraction index of the compensating patterns and a refraction index of the first electrodes being at least small than 0.5, and the refraction index of the first electrodes being substantially equal to a refraction index of the second electrodes.

2. The capacitive touch panel as claimed in claim 1, wherein the second electrodes are disposed on the first substrate.

3. The capacitive touch panel as claimed in claim 1, further comprising a second substrate parallel to the first substrate, and the second sensing series being disposed on the second substrate.

4. The capacitive touch panel as claimed in claim 1, further comprising an insulator layer, and the first sensing series and the second sensing series being disposed at two opposite sides of the insulator layer.

5. The capacitive touch panel as claimed in claim 4, further comprising a protection layer covering the second electrodes.

6. The capacitive touch panel as claimed in claim 4, wherein the compensating patterns comprises a plurality of first compensating portions connecting with the insulator layer, the first compensating portions are located between two adjacent first electrodes and corresponding to the second electrodes, and side surfaces of the first compensating portions contact side surfaces of the adjacent first electrodes.

7. The capacitive touch panel as claimed in claim 6, wherein the compensating patterns further comprises a plurality of second compensating portions connecting with the insulator layer, the second compensating portions are located between two adjacent second electrodes and corresponding to the first electrodes, and side surfaces of the second compensating portions contact side surfaces of the adjacent second electrodes.

8. The capacitive touch panel as claimed in claim 7, wherein a material of the compensating patterns comprises a dielectric material.

9. The capacitive touch panel as claimed in claim 8, wherein the refraction index of the compensating patterns is from 1.55 to 2.5.

10. The capacitive touch panel as claimed in claim 1, wherein the compensating patterns comprise a plurality of electrode compensating patterns electrically insulated from the first electrodes and the second electrodes.

11. The capacitive touch panel as claimed in claim 10, wherein each of the electrode compensating patterns is stripe-shaped.

12. The capacitive touch panel as claimed in claim 10, wherein at least a portion of the electrode compensating patterns are connected to one another.

13. The capacitive touch panel as claimed in claim 10, wherein a material of the electrode compensating patterns comprises indium tin oxide or indium zinc oxide.

14. The capacitive touch panel as claimed in claim 10, further comprising a insulator layer, and the first sensing series and the second sensing series being disposed at two opposite sides of the insulator layer.

15. The capacitive touch panel as claimed in claim 14, wherein the electrode compensating patterns and the first electrodes are coplanar disposed.

16. The capacitive touch panel as claimed in claim 14, wherein the electrode compensating patterns and the second electrodes are coplanar disposed.

17. The capacitive touch panel as claimed in claim 14, wherein a portion of the electrode compensating patterns and the first electrodes are coplanar disposed, and the rest electrode compensating patterns and the second electrodes are coplanar disposed.

18. The capacitive touch display panel as claimed in claim 1, wherein the first substrate is a transparent glass, a color filter, a plastic film, or a cover lens.

19. The capacitive touch display panel as claimed in claim 3, wherein the second substrate is a transparent glass, a color filter, a plastic film, or a cover lens.
